(19) United States
(12) Patent Application Publication
(10) Pub. No.: US 2010/0273623 A1
(43) Pub. Date: Oct. 28, 2010

(54) Folding Apparatus And Folding Method

(75) Inventors: Peter Knauer, Munster/Lech (DE); Axel Matheis, Neusass (DE); Heinz Roettger, Aystetten (DE)

Correspondence Address: COHEN, PONTANI, LIEBERMAN & PAVANE LLP, 551 FIFTH AVENUE, SUITE 1210, NEW YORK, NY, 10176, US

(73) Assignee: Manroland AG, Offenbach am Main (DE)

(21) Appl. No.: 12/582,324

(22) Filed: Oct. 20, 2009

(30) Foreign Application Priority Data
Oct. 20, 2008 (DE) 10 2008 052 151.5

(51) Int. Cl. B31B 1/14; B31B 1/26

(52) U.S. Cl. 493/356; 493/405

(57) ABSTRACT

A folding apparatus and method for a web-fed rotary press having a first folding jaw cylinder, a cross cutter by which a first web ribbon comprising a first quantity of printing stock webs is fed to the cross cutter and is cross cuttable into first print products by the cross cutter and a collection cylinder by which the first print products are subsequently cross folded by the collection cylinder and the first folding jaw cylinder. The apparatus also includes an auxiliary cross cutter which cross cuts a second web ribbon comprising a second quantity of printing stock webs into second print products. A transfer device is used to transfer the second print products produced from the second web ribbon to the collection cylinder. As a result, a first print product and a second print product are combined on the collection cylinder and are cross folded together when transferred to the first folding jaw cylinder.

### BACKGROUND OF THE INVENTION

1. Field of the Invention

The invention is directed to a folding apparatus and method and, more particularly, to a folding apparatus for a web-fed rotary press having a cross cutter, a collection cylinder and a folding jaw cylinder.

2. Description of the Related Art

A folding apparatus according to German Patent Application DE 10 2004 005 807 A1 discloses a conventional folding apparatus having, in addition to a standard basic folder (e.g., a cross cutter, a collection cylinder and folding jaw cylinder), an auxiliary cross cutter by which a second web ribbon comprising a second printing stock (e.g., salmon-colored paper) can be cut into second print products. The apparatus also includes a gripper cylinder for transferring the second print products to the collection cylinder upon which are also placed the first print products which were produced from a first web ribbon comprising a first printing stock (e.g., white paper) by the cross cutter associated with the collection cylinder. As a result, a first print product and a second print product are placed on top of one another on the collection cylinder and are cross-folded together by the collection cylinder and the folding jaw cylinder to form a complete product. Accordingly, the choice of printing stock and the choice of thickness of the two web ribbons, i.e., the choice of how many printing stock webs are to be placed on top of one another or inside of each other in one of the two web ribbons, is completely independent from the printing stock and thickness of the other web ribbon. The two print products that are collected and cross-folded together to form a complete print product have the same tabloid format. Consequently, the resultant complete print product has an insert and a cover in the same format but comprising different printing stocks.

There is currently an effort underway, particularly in newspaper printing, to produce print products with inserts in a smaller format than that of the newspaper (the “cover product”). To this end, it is known to use a skip slitter. Skip slitters are intermittent cutting knives which have a rotating, discontinuous blade, are aligned with the fold line of a former, and serve above the former as a longitudinal cutting device for a printing stock web. A length of the paper web or printing stock web corresponding to a sheet is then alternately provided, or not provided, with a longitudinal slit.

When the printing stock web, which is provided with longitudinal intermittent slits, is fed to a basic folder via the former, the web is initially cross-cut in a cross cutter so that a longitudinally folded sheet in double-sized format and two sheets in standard full-sized format that are placed one on top of the other are produced in an alternating manner. The cross cutter can be a pair of cutting cylinders, as is conventional, or a cutting knife cylinder which performs the cross-cut in cooperation with an adjoining folding cylinder or collection cylinder using a cutting knife which is pressed against the collection cylinder.

In a subsequent step, the small-format sheets (e.g., tabloid) and the longitudinally folded or quarter-folded large-format sheet (e.g., broadsheet) can be placed on top of one another on the collection cylinder so that a print product with an insert having half the page size of the cover is created after the cross fold produced by the collection cylinder in cooperation with a folding jaw cylinder. In so doing, the number of pages of the small-format insert is directly dependent on (i.e., twice as great) the number of pages of the large-format cover, and only final products with an even-numbered quantity of printing projects can be produced.

### SUMMARY OF THE INVENTION

It is therefore an object of the invention to provide a folding apparatus and a folding method by which print products composed of large-format cover products and small-format inserts can be produced in a more flexible manner.

This and other objects and advantages are achieved by a folding apparatus for a web-fed rotary press having a cross cutter, a collect cylinder and a first folding jaw cylinder, wherein a first web ribbon is fed to the cross cutter. In accordance with the invention, at least one former is arranged in front of the cross cutter and the auxiliary cross cutter, respectively. In addition, a longitudinal cutting device having a cutting knife aligned with the former fold is associated with the formers which are associated with the cross cutter. Here, however, a longitudinal cutting device is not provided at the former associated with the auxiliary cross cutter.

Accordingly, from supplied printing stock webs having the same width, products with any quantity of longitudinally folded printing projects in a large format (i.e., second print products) can be placed on any quantity of longitudinally cut sheets of a small format that is half the size of the large format (i.e., first print products). As a result, a large variety of final products can be produced whose cover product (e.g., in broadsheet format) is twice the size of the associated insert product (e.g., in tabloid format). The printing stock webs fed to a cross cutter as first web ribbon are thus longitudinally cut and placed one on top of the other, while the printing stock webs fed to the auxiliary cross cutter as second web ribbon are longitudinally folded before the two web ribbons are fed to the folding apparatus. Moreover, the cross fold of the large-format print product in the resultant complete product is thereby simultaneously the cross fold of the small-format print product which, due to its lack of a longitudinal fold, forms an insert with a page size that exactly conforms to the dimensions of the large-format print product.

In an embodiment, an auxiliary collection cylinder is advantageously arranged between the auxiliary cross cutter and the transfer device. Similarly to the collection cylinder, this auxiliary collection cylinder can be constructed as a pin-and-fold cylinder or as a gripper folding cylinder. When the second print products are placed on top of one another on the auxiliary folding cylinder during collection run production, a plurality of printing projects can also be placed on a printing project stack of first print products on the collection cylinder so as to increase the variety of production. In particular, a final product with four broadsheet printing projects and one tabloid insert can be produced in a simple manner from a half-format printing project.

It is advantageous to permit adjustment of the transfer device with respect to the collection cylinder so that it is also possible to produce only one web ribbon. In an embodiment, an additional folding jaw cylinder and a product delivery, which are each preferably adjustable on or off, are associated with the auxiliary collection cylinder to thereby also permit production from both web ribbons independently from one another.

A belt transfer can be provided as a transfer device. However, a pin cylinder arranged between the auxiliary collection cylinder and the collection cylinder has proven particularly advantageous. In cases in which no auxiliary collection cylinder is provided, it is possible to arrange the pin cylinder between the collection cylinder and the auxiliary cross cutter. As a result, an additional ribbon can be cut into products and supplied by the transfer device to the products from the ribbon located on the collection cylinder.

The two web ribbons preferably have the same width, the first web ribbon being guided by the cross cutter to the collection cylinder and the second web ribbon being guided by the auxiliary cross cutter and the transfer device. The two web ribbons can in turn comprise a plurality of printing stock webs when a corresponding former superstructure with corresponding turner bars is arranged in front of the cross cutter and the auxiliary cross cutter. However, a magazine superstructure would also be possible.

In another embodiment, an additional longitudinal cutting arrangement is advantageously disposed in front of the former superstructure, and a printing stock web is split by this additional splitter into partial webs which can be guided to the formers. As a result, the two web ribbons guided into the folding apparatus can be produced from an individual printing stock web coming from a production run. The print products produced from the second web ribbon can then be collected one or more times on the auxiliary collection cylinder before being transferred to the collection cylinder for collection on a first print product.

When two formers are associated with the auxiliary cross cutter, a final product with two broadsheet printing projects of four pages each, and a tabloid printing project of eight pages can be thus made from a six-page width production run.

Other objects and features of the present invention will become apparent from the following detailed description considered in conjunction with the accompanying drawings. It is to be understood, however, that the drawings are designed solely for purposes of illustration and not as a definition of the limits of the invention. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

An advantageous embodiment form is described more fully in the following with reference to the accompanying drawings in which:

FIG. 1 shows a schematic side view illustration of a folding apparatus in accordance with an embodiment of the invention; and

FIG. 2 shows a flow chart illustrating the folding method in accordance with an embodiment of the invention.

### DETAILED DESCRIPTION OF THE PREFERRED EMBODIMENTS

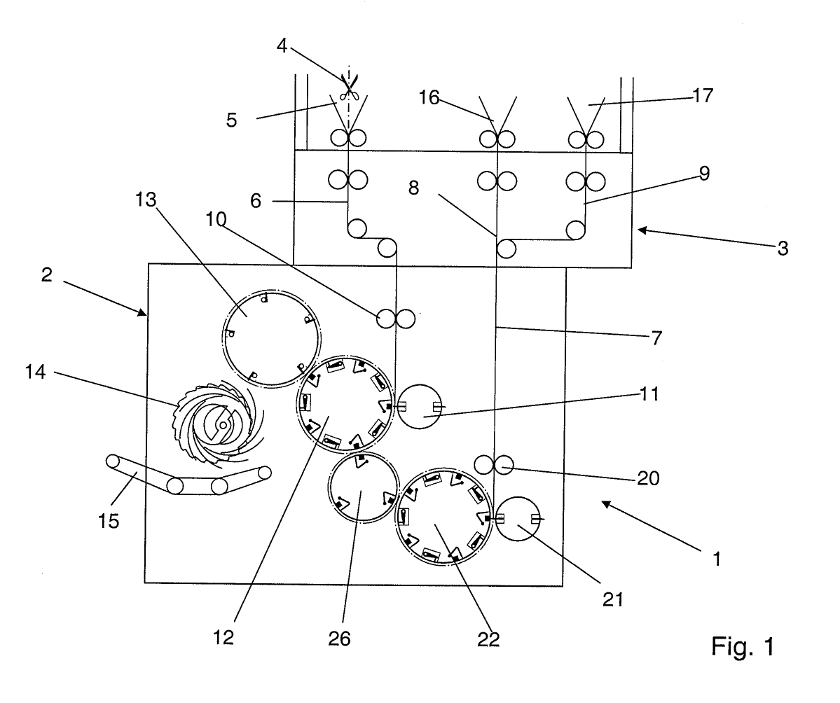

With reference to FIG. 1, the entire folding apparatus is designated by reference numeral 1, the basic folder is designated by reference numeral 2, and the overriding former superstructure is designated by reference numeral 3. With additional reference to FIG. 1, the former superstructure has three formers 5, 16, 17. A web ribbon 6 is guided by former 5 and fed to the basic folder 2 by different nipping rollers and guide rollers (not shown in detail). In contrast, web ribbons 8, 9, respectively, are guided by formers 16 and 17, but are placed one above the other before reaching the basic folder, and are accordingly fed to the basic folder 2 as a total ribbon 7 comprising two longitudinally folded individual ribbons placed one above the other. A longitudinal cutting device 4, symbolized by scissors, is provided at the edge of the former 5. The first web ribbon is cut longitudinally by this longitudinal cutting device 4, as a result of which the first web ribbon 6, as it enters the basic folder 2, has the same width as the second ribbon 7 which is not longitudinally slit but which is cross folded.

Next, the first web ribbon 6 is fed in a known manner to a collection cylinder 12 by a pair of nipper rollers 10 and a cutting knife cylinder 11 and, in so doing, is cut into single copies by the rotating cutting knives of the cutting knife cylinder 11 that press against corresponding counter-surfaces on the collection cylinder 12. Contrastingly, the second web ribbon 7 is fed to a secondary, auxiliary folding unit having at its input a pair of nipper rollers 20, between which the web ribbon 7 is guided to an auxiliary cutting cylinder 21 that serves as an auxiliary cross cutter and whose cutting knives in turn cross-cut the second web ribbon into single copies in cooperation with corresponding counter-surfaces on an auxiliary collection cylinder 22. The individual copies are then pinned up on the auxiliary collection cylinder 22 which is constructed as a pin-and-fold cylinder and, depending on the desired final product, are transferred collected or uncollected to a transfer cylinder 26 which is likewise constructed as a pin-and-fold cylinder, and by which the auxiliary cross cutter communicates with the collection cylinder 12.

In an embodiment, the collection cylinder 12 is also constructed as a pin-and-fold cylinder. Here, another section of collected or uncollected single copies coming from the second ribbon 7 can also be pinned up on a first section of uncollected single copies cut from the first ribbon 6. To this end, the pins of the transfer cylinder 26 are laterally offset relative to the pins of the two collection cylinders 12, 22 so that they act on the print product at neighboring positions. While the pins of the transfer cylinder 26 receive the second products from the auxiliary collection cylinder 22, the pins of this auxiliary collection cylinder 22 are simultaneously reset.

During the transfer to the (main) collection cylinder 12, the pins of the collection cylinder 12 receive the second print products on the first print products that are already pinned up, while the pins of the transfer cylinder 26 are reset. These first and second print products which are placed one upon the other are then together cross folded when transferred to a folding jaw cylinder 13 and are delivered to a delivery belt 15 by a fan wheel 14.

It can be seen that, depending on the configuration of the former superstructure 3, the quantity, number of pages and number of webs of the supplied ribbons and depending on whether one or more collection runs or no collections are performed at the auxiliary collection cylinder 22, a large number of products can be produced, which is especially advantageous when the first print products are, at most, half the size of the second print products. Consequently, the common cross folding in cooperation between the collection cylinder 12 and the folding jaw cylinder 13 results in a final product containing a large-format cover product and an insert in a smaller format, but which have a common cross fold. A product of this kind would be, for example, a broadsheet newspaper with an insert, such as a tabloid advertisement or a tabloid television guide.

In the exemplary embodiments shown herein, the two longitudinally folded web ribbons 8, 9 are in broadsheet format and are collected one time on the auxiliary collection cylinder 22 which results in a broadsheet product with a total of four printing projects, each of which is placed on a first print product in tabloid format that is cut from the first partial ribbon 6 when it is transferred by the transfer cylinder 26 from the auxiliary collection cylinder 22 to the collection cylinder 12. Accordingly, the common cross folding at the folding jaw cylinder 12 yields a print product with four broadsheet printing projects and one printing project in tabloid format inserted therein.

The disclosed embodiments of the invention provide a particular advantage in that the number of pages of the tabloid format is not dependent on the number of pages of the broadsheet format, and can be adjusted by the configuration of the former superstructure and by the thickness of the first web ribbon. The number of pages and number of printing projects in broadsheet format can be adjusted by the type of production run at the auxiliary collection cylinder, by the thickness and quantity of the printing stock webs combined as a second web ribbon and by the configuration of the formers.

Therefore, modifications of the embodiments shown herein are not only encompassed by the invention, but are necessary to produce a wide variety of print products. For example, for a print product with six printing projects in broadsheet format and an insert with a printing project in tabloid format, an additional former could be associated with the auxiliary cross folder, whereas the number of pages of the tabloid insert can also be increased by use of an additional former that is associated with the parent folding unit 11, 12, 13 or by using the former 5 to guide a plurality of webs. In another embodiment, the formers 5, 16, 17 are constructed such that they are displaceable so that they can be associated selectively with the auxiliary cross folder or the parent cross folder.

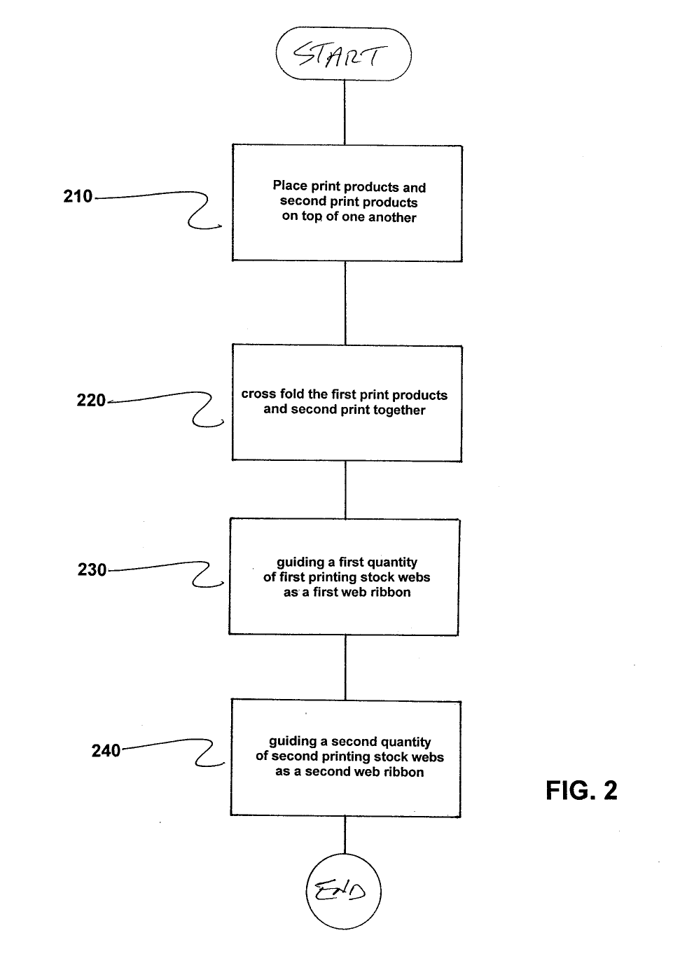

FIG. 2 is a flow chart illustrating the folding method in accordance with an embodiment of the invention. Print products and second print products are initially placed on top of one another on a collection cylinder 12 assigned to the first print products and second print products, as indicated in step 210.

Next, the first print products and second print products are cross folded together such that the first print products and second print products are respectively cross cuttable from web ribbons fed to a plurality of separate cross cutters 11, 21 of the folding apparatus 1, as indicated in step 220.

A first quantity of first printing stock webs, which is fed to the cross cutter 11, is guided as a first web ribbon 6 by a former 5 and the first web ribbon is longitudinally cut across its center, as indicated in step 230.

A second quantity of second printing stock webs 8, 9, which is fed to an auxiliary cross cutter 21 of the plurality of separate cross cutters, is guided as a second web ribbon 7 by a plurality of formers 16, 17 and the second web ribbon is longitudinally folded along its center, as indicated in step 240.

Thus, while there are shown, described and pointed out fundamental novel features of the invention as applied to preferred embodiments thereof, it will be understood that various omissions and substitutions and changes in the form and details of the apparatus and method illustrated, and in their operation, may be made by those skilled in the art without departing from the spirit of the invention. Moreover, it should be recognized that method steps and structures shown and/or described in connection with any disclosed form or embodiment of the invention may be incorporated in any other disclosed or described or suggested form or embodiment as a general matter of design choice.

What is claimed is:

1. A folding apparatus for a web-fed rotary press, comprising:
a first folding jaw cylinder;
a cross cutter configured to receive a first web ribbon comprising a first quantity of printing stock webs, the first web ribbon being fed to the cross cutter and cross cuttable into first print products by the cross cutter;
a collection cylinder, the first print products being cross folded by the collection cylinder and the first folding jaw cylinder;
an auxiliary cross cutter configured to receive a second web ribbon comprising a second quantity of printing stock webs, the second web ribbon being cuttable into second print products by the auxiliary cross cutter;
a transfer device for transferring the second print products to the collection cylinder so that at least one of the first print products and at least one of the second print product are combined on the collection cylinder and are cross folded together when transferred to the first folding jaw cylinder;
at least one former arranged in front of the cross cutter and the auxiliary cross cutter, respectively; and
a longitudinal cutting device having a cutting knife aligned with a former fold, said longitudinal cutting device being associated only with the at least one former which is associated with the cross cutter.

2. The folding apparatus according to claim 1, further comprising an auxiliary collection cylinder arranged between the auxiliary cross cutter and the transfer device.

3. The folding apparatus according to claim 1, wherein the transfer device, individually or in combination with the auxiliary cross cutter and the auxiliary collection cylinder, is adjustable with respect to the collection cylinder.

4. The folding apparatus according to claim 3, further comprising:
a second folding jaw cylinder having an associated product delivery, said second folding jaw cylinder being associated with the auxiliary collection cylinder.

5. The folding apparatus according to claim 1, wherein the transfer device comprises a pin cylinder which is arranged between the collection cylinder and one of the auxiliary collection cylinder and the auxiliary cross cutter.

6. The folding apparatus according to claim 1, further comprising a fan wheel and a delivery belt arranged subsequent to the first folding jaw cylinder.

7. The folding apparatus according to claim 1, further comprising:
a former superstructure arranged in front of the cross cutter and the auxiliary cross cutter; and
a longitudinal cutting arrangement arranged in front of the former superstructure, said longitudinal cutting arrangement being configured to cut a printing stock web into partial webs which are guideable to said at least one former.

8. The folding apparatus according to claim 7, wherein at least one of the at least one former, the longitudinal cutting device and the longitudinal cutting arrangement arranged in front the former superstructure is positionally adjustable so that a width of a format of the first print products and the second print products is variable.

9. The folding apparatus according to claim 2, wherein the transfer device, individually or in combination with the auxiliary cross cutter and the auxiliary collection cylinder, is adjustable with respect to the collection cylinder.

10. The folding apparatus according to claim 1, wherein the cross cutter comprises one of a cutting knife cylinder and a pair of cutting cylinders.

11. The folding apparatus according to claim 1, wherein the collection cylinder comprises one of a pin-and-fold cylinder and a gripper folding cylinder.

12. The folding apparatus according to claim 1, wherein the auxiliary cross cutter comprises one of a cutting knife cylinder and a pair of cutting cylinders.

13. The folding apparatus according to claim 2, wherein the auxiliary collection cylinder comprises one of a pin-and-fold cylinder and gripper folding cylinder.

14. A folding method, comprising:
guiding a first quantity of first printing stock webs by a former and longitudinally cutting the first web ribbon across its center, the first quantity of first printing stock webs comprising forming a first web ribbon;
feeding the first web ribbon to a cross cutter;
guiding a second quantity of second printing stock webs by a plurality of formers and longitudinally folding the second quantity of second printing stock webs along their centers, the second quantity of second printing stock webs forming a second web ribbon;
feeding the second web ribbon to an auxiliary cross cutter;
crosscutting the first and second web ribbons by at least two separate cross cutters of a folding apparatus to form first print products and second print products, respectively;
placing at least one of the first print products and at least one of the second print products on top of one another on a collection cylinder assigned to the first print products and the second print products; and
cross folding together the one of the first print products and the one of the second print products.

15. The folding method according to claim 14, wherein the first printing stock web and the second printing stock web have identical widths.

16. The folding method according to claim 14, further comprising;
feeding the first print products to the collection cylinder on a direct path by a cross cutter of the at least two separate cross cutters that is associated with the collection cylinder; and
feeding the second print products to the collection cylinder by an auxiliary cross cutter of the at least two separate cross cutters, an auxiliary collection cylinder and a transfer device which is arranged between the collection cylinder and the auxiliary collection cylinder.

17. The folding method according to claim 14, wherein the first quantity of printing stock webs and the second quantity of printing stock webs differ from one another.

18. The folding method according to claim 14, wherein a plurality of the second print products are collected on the auxiliary collection cylinder before being transferred to the one of the first print products on the collection cylinder.

19. The folding method according to claim 14, wherein the second print products are in broadsheet format and the first print products are in tabloid format.

20. The folding method according to claim 14, wherein two printing stock webs are placed above one another for the second print products, and the second print products are collected at least once on the auxiliary collection cylinder so that every final product has four large-format printing projects and a small-format printing project.

21. The folding method according to claim 14, wherein final products with an even-numbered quantity of broadsheet printing projects are produced in a collection run with any quantity of tabloid printing projects.

22. The folding method of claim 14, wherein the transfer device comprises a pin-and-fold cylinder.

23. The folding method of claim 21, wherein the quantity of broadsheet printing projects comprises four broadsheet printing projects.

24. The folding method of claim 21, wherein the quantity of the tabloid printing projects in the collection run comprises an odd-numbered quantity.

25. The folding method of claim 21, wherein the tabloid printing projects comprise only one tabloid printing project.
